(19) United States
(12) Patent Application Publication
(10) Pub. No.: US 2003/0191547 A1
(43) Pub. Date: Oct. 9, 2003

(54) Golf game management system

(76) Inventor: Kevin C. Morse, Flint, MI (US)

Correspondence Address: HARSHAW RESEARCH INCORPORATED, P O BOX 418, OTTAWA, KS, 66067, US

(21) Appl. No.: 10/413,035

(22) Filed: Apr. 14, 2003

Related U.S. Application Data
(63) Continuation-in-part of application No. 09/879,635, filed on Jun. 12, 2001, now abandoned.

(51) Int. Cl. G06F 155/00

(52) U.S. Cl. 700/91

(57) ABSTRACT

A golf game management system for maintaining golf course, player, and golf ball location information includes a central computer having a first CPU and a mobile interface unit having a second CPU. A course database is connected to the first CPU and includes golf course records. A player database is also connected to the first CPU and includes a plurality of individual player records. The central computer and mobile interface unit each include a transmitter and receiver for exchanging database information, the mobile unit having a memory for storing requested records and a display for displaying them. The mobile unit includes a GPS receiver for determining its current geographic location and means for correlating that location with a digital map of a selected golf course. The system includes a golf ball having a receiver and sound generator that is energized upon receiving a signal from the mobile interface unit.

### CROSS-REFERENCE TO RELATED APPLICATIONS

This application is a continuation-in-part of application Ser. No. 09/879,635, filed Jun. 12, 2001.

### BACKGROUND OF THE INVENTION

This invention relates generally to electronic information systems and, more particularly, to a golf game management system for managing and providing golf course, player, and golf ball location information to a golfer at a remote location on a golf course.

Golf is one of the fastest growing sports in the United States and is certainly very popular world-wide. Although most golfers play the same course repetitively, they often desire to play other courses while vacationing away from home or while traveling for occupational reasons. When playing a familiar course, a golfer may desire to know what size clubs were used previously relative to a particular golf hole, what scores were previously attained, or other statistics. When playing an unfamiliar golf course, a golfer may desire detailed information about the layout or topology of the golf hole including distance information.

Several systems have been proposed in the art for measuring the distance between a tee or golf ball and a golf green, cup, or other landmark. Other systems have been proposed for tracking player performance statistics. Although assumably effective for their intended purposes, the existing systems still do not provide a portable interface unit that can remotely manage golf course, player, and golf ball location information.

Therefore, it is desirable to have a system in which a golfer can remotely access, store, and display selectable golf course records and selectable player records. Further, it is desirable to have a system which can energize a golf ball to audibly identify its location and then to identify the geographic position of a mobile interface unit that is positioned adjacent the found ball.

### SUMMARY OF THE INVENTION

A golf game management system according to the present invention includes a central computer server unit having a first central processing unit (“first CPU”). The server includes a golf course database and a player database stored in a memory connected to the first CPU. Each database includes records containing individual data fields having information regarding predetermined golf courses or player information associated with a particular golf course previously played or presently being played by a player. The system includes a mobile interface unit which may be carried by a user during game play or mounted to a golf cart for use during play. The mobile interface unit includes a second central processing unit (“second CPU”) and is equipped to transmit requests to the central server for selected golf course or player records. When the server transmits the selected records in reply, the mobile interface unit receives and stores them in a memory component and may display them upon a digital display. The mobile interface unit further includes a GPS receiver whereby the actual geographic position thereof may be determined using the global positioning satellite system.

The golf game management system includes a special golf ball having a shock absorbent outer shell and defining an interior chamber. A micro-battery, miniature receiver, and sound generator are positioned within the chamber. The second CPU and transmitter of the mobile interface unit are adapted to cooperatively transmit an actuation signal which enables the micro-battery to energize the sound generator upon receipt of the actuation signal by the miniature receiver. The sound emanating from the ball allows the golfer and mobile interface unit to locate the ball and to position the mobile unit adjacent the ball. Subsequent activation of the GPS receiver allows the current geographic position of the ball to be calculated and this position may be correlated with a digital map representation of the present golf course.

The mobile interface unit allows player statistics stored at the central server to be remotely updated during or after game play. Access to the server may alternatively be established through the Internet. In addition, the second CPU may be programmed and equipped to recognize and respond to voice commands.

Therefore, a general object of this invention is to provide a golf game management system which maintains golf course and player databases at a central computer server location and which may be remotely accessed by a mobile interface unit.

Another object of this invention is to provide a system, as aforesaid, which selectably displays at a remote location during game play a digital map representation of a selected hole of a selected golf course.

Still another object of this invention is to provide a system, as aforesaid, which selectably displays player performance data at a remote location during game play.

Yet another object of this invention is to provide a system, as aforesaid, in which player performance data may be updated during game play.

A further object of this invention is to provide a system, as aforesaid, which manages golf ball location by enabling a golf ball to be audibly located.

A still further object of this invention is to provide a system, as aforesaid, which allows the geographic position of the mobile interface unit to be determined using GPS signals and thus allows the geographic position of the golf ball to be determined when the mobile interface unit is adjacent the golf ball.

Another object of this invention is to provide a system, as aforesaid, in which the mobile interface unit may be controlled with voice commands.

Still another object of this invention is to provide a system, as aforesaid, in which player golf club selections may be automatically identified and recorded by the system using radio frequency identification technology.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a schematic illustration of a golf game management system according to a preferred embodiment of the present invention;

FIG. 2 is a schematic illustration of a mobile interface unit as in FIG. 1 in use in locating a golf ball;

FIG. 3 is one representative view of a display portion of the mobile interface unit;

FIG. 4a is a view of the display portion of the mobile interface unit as in FIG. 3 during game play;

FIG. 4b is an updated view of the display portion of the mobile interface unit as in FIG. 4a showing game progression;

FIG. 5a is a further updated view of the display portion of the mobile interface unit as in FIG. 4b showing game progression;

FIG. 5b is a still further updated view of the display portion of the mobile interface unit as in FIG. 5a showing game progression;

FIG. 6 is a cross-sectional view of a golf ball according to the present invention; and

FIG. 7 is a block diagram of the system according to the present invention.

### DESCRIPTION OF THE PREFERRED EMBODIMENT

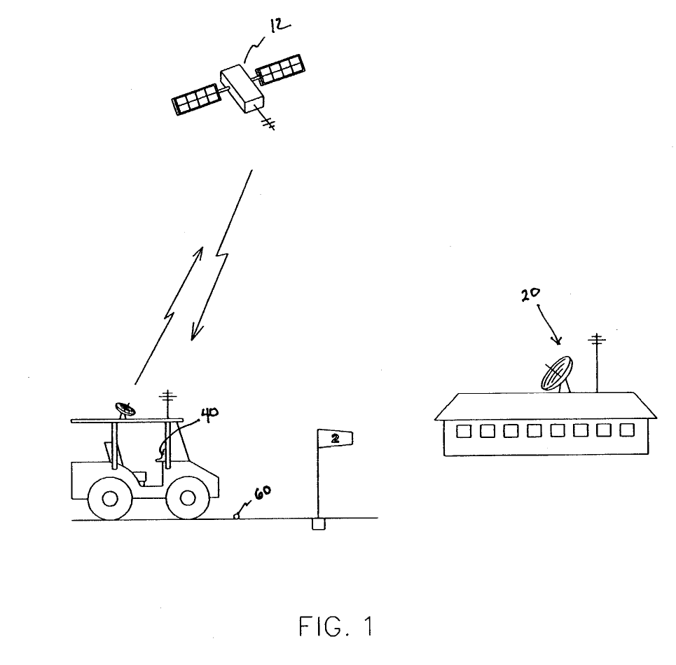

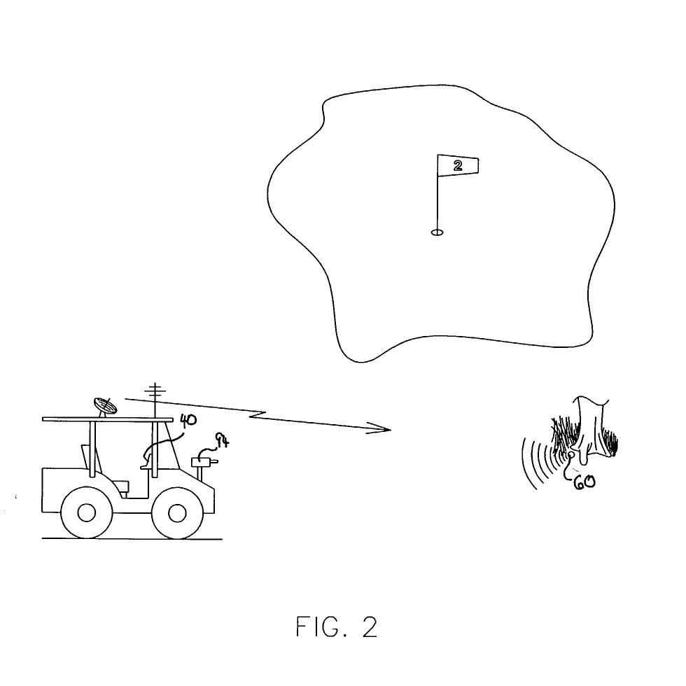

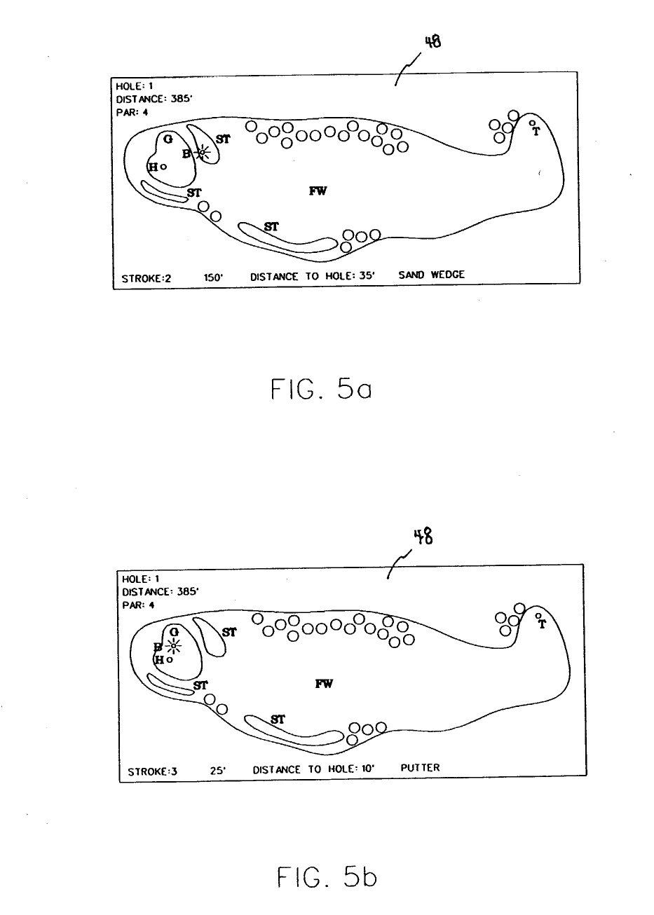

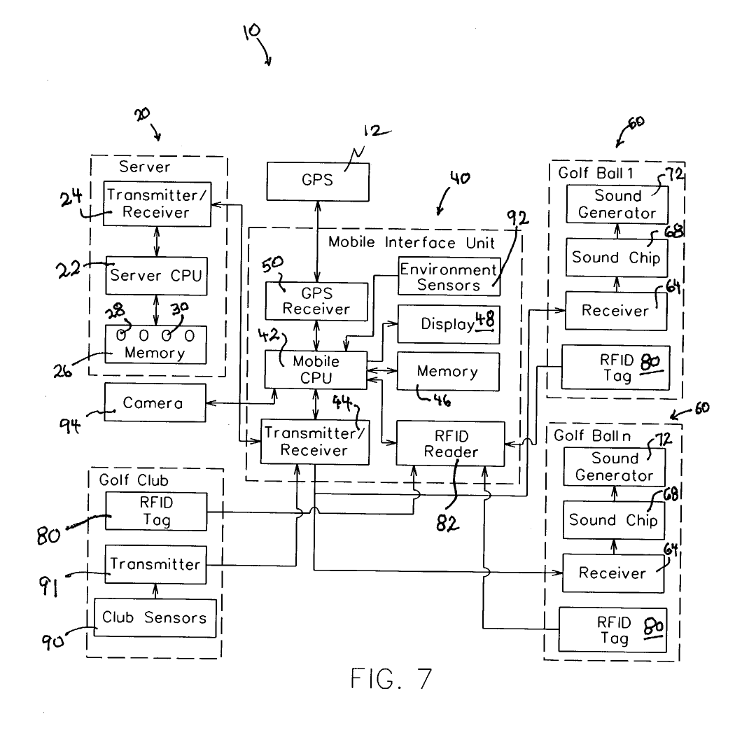

A golf game management system 10 according to a preferred embodiment of the present invention will now be described with reference to FIGS. 1 through 7 of the accompanying drawings. The golf game management system 10 includes a central computer server 20 having a central processing unit (“first CPU”) 22 (FIG. 7). A transceiver 24 having a transmitter and receiver is operatively connected to the first CPU 22. A memory 26 is also connected to the first CPU 22. A course database 28 is stored in the memory 26 and includes at least one golf course record containing a plurality of individual data fields. The data fields of each golf course record include a digital map representation of a particular golf course as well as information pertinent to each hole of the particular golf course such as, but not limited to, GPS geographic coordinates defining the actual physical boundaries of the golf hole, distance between the tee and the green, cup, hazards, etc. The exact geographic coordinates of a golf hole are such that they can be correlated with exact and actual GPS geographic coordinates of a mobile interface unit as will be described in more detail later. Data fields may even store the flag placement on any given day. Therefore, the course database, and a digital representation of each golf hole in particular, may be updated daily. A plurality of golf records corresponding to a plurality of golf courses may be stored in the course database of the central server 20. In fact, golf records representing golf courses from around the country or world may be included in the course database so that a user may obtain information that will be helpful in playing any desired course.

A player database 30 is also stored in the memory 26 of the central server 20 (FIG. 7) and is thus connected to the server CPU 22. The player database 30 includes a plurality of player records, each record containing a plurality of individual data fields having data indicative of individual player statistics. The data fields of a particular player record are associated with a particular golf course selected from the golf course database. These player statistics may include, but are not limited to, previous club selections for each golf hole associated with the selected golf course, previous distances a ball was hit relative to each hole associated with the selected golf course, previous and average scoring for each hole associated with the selected golf course. Obviously, many other golf statistics may be kept as data fields for each player record. It is understood that the course and player databases may be accessed from remote computers using the Internet or other network access means.

The central server transceiver 24 is capable of receiving signals requesting selected course or player records. The first CPU 22 is programmed to recognize these signals and to retrieve the requested signals from the respective databases in memory 26. Then, the first CPU 22 is capable of directing the server transceiver 24 to transmit these signals into the ambient air. These signals will hereafter be referred to as first and second signals so as to represent a requested golf course record and a requested player record, respectively.

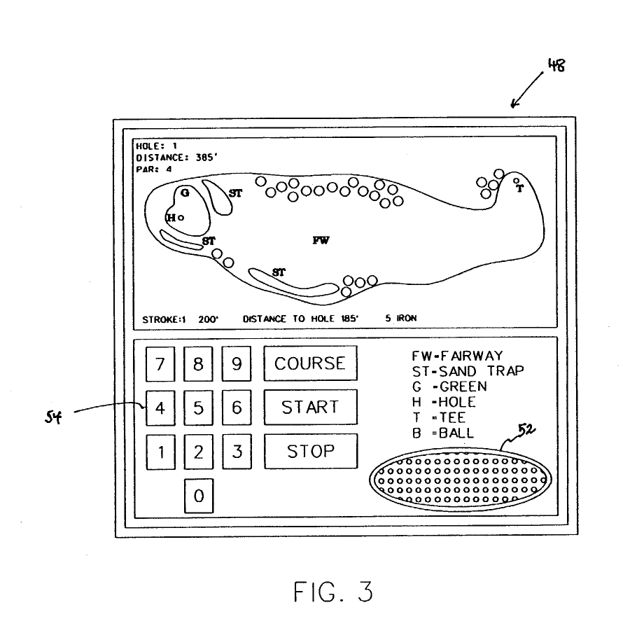

The golf game management system 10 further includes a mobile interface unit 40. This is a portable electronic device that may be either carried by a golfer during game play or mounted to a golf cart like a laptop computer. The mobile interface unit 40 includes a central processing unit (“second CPU”) 42 (FIG. 7). The second CPU 42 is operatively connected to a transceiver 44 having both a transmitter and receiver. The second CPU 42 is further connected to a memory 46 and to a display unit 48, as to be further described below. The mobile interface unit receiver is capable of receiving the first and second signals from the central server and delivering them to the second CPU 42 which stores the transmitted requested records in the mobile interface unit memory 46. A digital map representation of a selected course as well as information from corresponding data fields may be displayed on the display 48 as shown in FIGS. 3-5b. The selected player record may be similarly displayed (not shown).

A global positioning system (GPS) receiver 50 is operatively connected to the second CPU 42 in the mobile interface unit 40 (FIG. 7). Upon demand by the second CPU 42, the GPS receiver 50 receives data from GPS satellites 12 such that the second CPU is able to determine the geographic position of the mobile interface unit 40. Therefore, the actual and exact geographic position of a golf ball may be determined when the mobile interface unit 40 is positioned adjacent the golf ball.

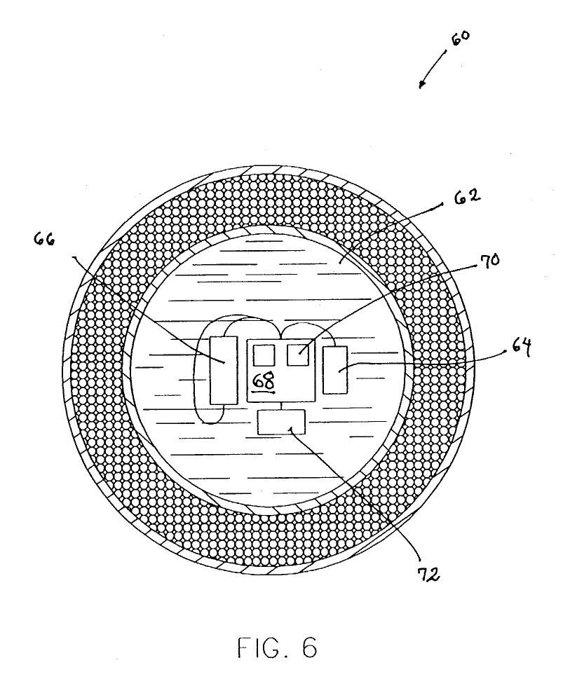

The system 10 includes a uniquely designed golf ball 60. The golf ball 60 includes a shock absorbent outer housing defining an interior chamber 62 (FIG. 6). A miniature receiver 64 is positioned in the chamber and is electrically connected to a micro-battery 66 also positioned therein. A sound generator 72 such as a piezoelectric transducer is also positioned within the chamber 62 and is connected to the micro-battery 66. Upon selection by a user, the mobile interface unit CPU 42 and corresponding transmitter cooperate to send an actuation signal to the golf ball 60. When the actuation signal is received by the miniature receiver 64, the miniature receiver allows current from the micro-battery 66 to energize the sound generator 72. Thus, the ball may be audibly located. It is understood that the sound generator may be a simple beeper or a more advanced speaker device. A digital sound chip 68 may also be positioned within the chamber 62 and be operatively connected intermediate the miniature receiver 64 and the sound generator 72. The sound chip 68 includes a memory 70 capable of digitally storing a plurality of messages. The messages may be informational such as “over here”, complimentary such as “nice shot”, or humorous such as “out of bounds again?!”. It is understood, of course, that the aforesaid messages are only representative and not limiting. The digital sound chip 68 is operatively connected to the sound generator 72 and is capable of delivering a respective message thereto when energized.

The data displayed on the display 48, operation of the GPS receiver 50, requests for selected course and player records, ball audible actuation, and other system functions may be accomplished via voice activation or verbal instruction. A microphone 52 mounted on the front panel of the display 48 receives voice commands and converts them to a digital form communicated to the second CPU 42 (FIG. 3). Verbal orders may be predetermined or prerecorded into the mobile interface unit memory 46. For example, “GPS update”, “turn ball on”, or “display next hole” are representative of commands which may be prerecorded and associated with second CPU operations. Microchips and software to provide voice activated operations are known and can recognize basic commands or commands previously recorded by a user. It is understood that the mobile interface unit 40 may also include a speaker (not shown) whereby data may displayed or audibly announced. For example, upon calculating a current ball position, the second CPU may direct the speaker to announce “42 yards to the cup”.

The first and second CPU's each include circuitry for updating course and player records. The mobile interface unit 40 includes a keypad 54 for gathering user data relative to club selection, scoring, etc. This information may be transmitted to the central server 20 by the mobile transmitter during game play or over the Internet at a later time. The central server CPU 22 is configured to remove previous data from a respective data field of a respective record and to replace that data with the newly gathered data. As a result, various other data fields may be recalculated by the first CPU, such as average scoring, clubs used, etc.

User data relative to club selection may be gathered automatically using Radio Frequency Identification tags (RFID) positioned on each golf club as described below. Placing a RFID tag on each club or even on the ball and in communication with the second/mobile CPU 42 enables a user to record which club or even which ball was used for each shot. This data can then be correlated and transmitted to the first/server CPU 22 in the manner previously described and stored in the appropriate database. RFID tags are wireless transmitters and receivers that communicate electronic signals. The transmitter tags 80 are placed on the device to be tracked and a RFID reader 82 is positioned on the mobile interface unit 40 for communication with or being electrically connected directly to the mobile CPU 42 (FIG. 7). RFID tags may be active or passive. Active RFID tags use a battery to increase the range of the transmitter. Passive RFID tags derive power from the reader by absorbing some of the energy from a signal and uses that energy to power its transmitter. This characteristic enables a passive tag to have an almost infinite life at a low cost and in a small package.

The present invention employs passive tags attached to each golf club (FIG. 7). Each passive transmitter tag 80 embodies a unique identifier, such as a numeric or alphanumeric string or other digital representation. A portion of each identifier identifies the type of club, such as a driver, nine iron, putter, and so on. Each tag may be attached to a respective club at a point of manufacture or at a later time as a laminated sticker applied to the shaft or as part of a hand grip. The reader 82 receiver tag includes circuitry or may be otherwise programmed to associate a predetermined club with each passive transmitter tag 80 for communicating this data to the second/mobile CPU 42. RFID tags having a limited transmission/receiving capability would be preferred so that the transmitter tag 80 closest to the mobile interface unit 40 will be read and identified by the reader 82 and not be confused with transmitter tags on other clubs still stored in a golf bag. In fact, a selected club and its respective transmitter tag 80 may need to be scanned in front of the reader 82 to achieve identification. Although RFID tags are the preferred mode of tracking club selection, barcodes, Weigand sensors, magnetic strips, and ROM chips would also be suitable.

Club or ball information received by the reader 82 and communicated to the mobile CPU 42 may then be communicated to the server CPU 22 for storage in appropriate database memory locations. More particularly, the reader 82 includes circuitry, or is otherwise programmable, to recognize the unique identifier of a particular transmitter tag 80 and to correlate this to a corresponding golf club to which the transmitter tag 80 is attached. The mobile CPU 42 then updates the appropriate player record data with this information. In this manner, the player record is updated with each swing of a club throughout the golf game and this information is available upon future use of the system. It should be appreciated that transmitter tags may also be coupled to selected golf balls as well for keeping track in the player record of which ball was struck on each golf shot.

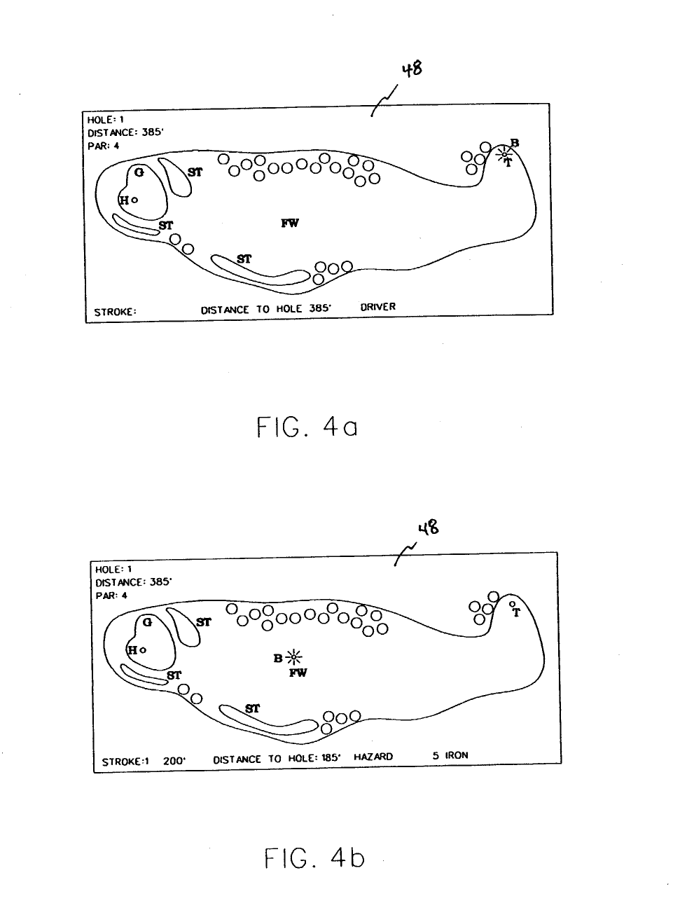

Additionally, the mobile CPU 42 is capable of calculating a desired or hypothetical golf shot trajectory 86 from any current golf ball position (FIG. 4b). For example, the mobile CPU 42 is capable of calculating and displaying a desired distance and ball path for a first shot from the tee of any particular hole or for displaying a desired distance and ball path of a second shot from a fairway toward a green. These calculations may be accomplished by the CPU by a comparison of the golf hole geographic boundary coordinates, geographic coordinates of hazards, distance from a current ball position to the green, average club distances, etc. A calculated “hypothetical” trajectory 86 may be displayed on the digital display unit 48 before or after a user's actual golf shot. Further, the mobile CPU 42 is also capable of displaying the trajectory 86 of the user's actual golf shot through a comparison of the GPS coordinates defining a present geographic position and the immediately previous present geographic position. The hypothetical trajectory and trajectory of an actual shot may be displayed together with a digital map representation of a respective golf hole for user comparison.

An extension of the feature described immediately above is that a user may review multiple previous shots on that same golf hole, this review being possible before or after making a present golf shot. In other words, the trajectories and data from previous rounds of golf are all stored in the player record relative to a selected golf course and are available for real-time review while playing a present round of golf. The mobile interface unit 40 even allows a user to review prior game play by a golf professional whereby to gain instruction or strategy before making his own shot. Entire game reviews, showing trajectory or other data may be displayed on the digital display 48 or through an Internet connection with the remote server 20. It should be remembered that any prior game summaries, player records, or the like must be downloaded to the mobile interface unit CPU 42 from the remote server as described previously.

In another aspect of the present invention, a user's golf clubs may be instrumented with a variety of sensors 90 (FIG. 7) for providing useful data for storage in the user's player record. Of particular interest for later analysis of the user's game, skill, or improvement would be club speed, ball impact force, ball speed, intended ball direction versus actual direction, ball spin, and the like. This information may be gathered using instruments such as accelerometers, strain gauges, pressure transducers, GPS units, and other suitable sensors. Club speed may be calculated using an angular rate sensor. That information combined with club mass and ball mass may be used to calculate the force with which a ball was struck. An accelerometer positioned on a club head would be a suitable alternative for calculating impact force upon a ball. These sensors 90 are electrically connected to a transmitter 91 mounted to the selected golf club for communicating data to the mobile CPU 42 (FIG. 7) where the appropriate player record may be updated as described previously. Similar instrumentation could alternately be mounted within the uniquely designed golf ball 60 described above (instrumentation not shown in FIG. 6) although mounting the instruments on selected golf clubs is preferred since golf balls may become lost during game play.

In yet another aspect of the present invention, a plurality of environmental sensors 92 are mounted on the mobile interface unit 40 and are electrically connected to the mobile CPU 42. Preferably, these environmental sensors 92 include a precipitation, wind, and temperature sensor although other environmental sensors may also be included. Data collected by the environmental sensors 92 may be recorded in the user's player record in the manner previously described. As weather elements such as temperature, wind, and rain can have a dramatic effect on player performance, it is important that this type of data be included in the player's statistics to make later review of the golf round more meaningful.

Further, the present system 10 includes a camera 94 electrically connected to the mobile interface unit 40 (FIG. 7) and which may be mounted to a golf cart (FIG. 1). The camera 94 may be used by a golfer during a golf game to record a particular golf shot. The mobile CPU 42 is capable of saving the video clip as digital data and for recording it in the respective player record relative to a selected golf hole for later review by the golfer or others. This feature is a mechanism for recording great shots for later instruction of more novice golfers or for preserving the shot whereby to boast to others. It should also be appreciated that a video clip or other communication may be transmitted to other mobile interface units for real-time review during game play. This would allow a large group of golfers to stay informed as to the progress of other golfers in their party. Such real-time communications may be accomplished via transmissions to the central server CPU 22. Of course, voice transmissions may be accomplished with a two-way cart-to-cart radio transmission system using conventional technology, e.g. cellular, digital, or radio frequency components.

In use, the course 28 and player 30 databases are stored in the memory 26 of the central computer server 20. Of course, these databases need only be created once but may be updated repetitively with new or additional golf course data and the player database may be updated with new users or as old users enter data during or after playing a respective golf course. During game play, a user having access to a mobile interface unit may request a particular golf course record or player record from the central server 20. This data is transmitted to the requesting mobile interface unit 40 where it is stored and selectively displayed. It is obvious that multiple mobile interface units may be in use at the same time, each transmitting and receiving at a different frequency to avoid interference. The user may use the information from the requested records to assist in deciding what club to use for a present shot, to review past performance, etc. The user may update a player record immediately from the mobile interface unit 40 or later via the Internet.

Following a golf shot, the user may instruct the second/mobile CPU 42 and mobile interface unit transmitter to transmit an actuation signal and thus energize the sound generator 72 of the golf ball 60. When the golf ball 60 is located and the mobile interface unit 40 is positioned adjacent the ball, the user may actuate the GPS receiver 50 so as to calculate the present geographic position of the ball. This information may be correlated with the digital map representation of the originally selected golf course record (which is now stored in the mobile interface unit memory) and the display 48 may be updated. The distance from the present ball position to the green or cup may also be calculated and displayed. It should be appreciated that each updated display of a golf hole relative to the currently calculated golf ball position is unique rather than merely a generic view of the golf hole based on a general position of the ball. For example, the digital display is generated based on the current ball position as it relates to the exact geographic boundaries of the golf hole rather than reverting to one of two or three predetermined generic displays for that hole. This would allow a display to be generated even if the ball location was “out-of-bounds”.

Accordingly, the golf game management system according to the present invention allows a golfer to manage golf course topography, distance information, past performance statistics, and golf ball location information from a remote location during game play.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A golf game management system for use by a golfer playing a round of golf with a plurality of golf clubs, said golf game management system for acquiring golf course, player, and golf ball location information upon demand by a golfer during game play, said system comprising:
a mobile interface unit having a central processing system (“CPU”);
means connected to said CPU for receiving a user-selected golf course record from a remote computer server having a course database, said course database having at least one golf course record containing a plurality of data fields;
wherein said plurality of data fields of said at least one golf course record includes a digital map representation of a corresponding golf course and geographic coordinates of the boundaries of each hole of said corresponding golf course;
means connected to said CPU for receiving a user-selected player record from said remote computer, said remote computer including a player database having a plurality of player records with each player record having a plurality of data fields indicative of individual player information;
a memory connected to said CPU for storing said user-selected golf course record and said user-selected player record;
a GPS receiver for receiving GPS signals and for determining an exact current geographic position of said mobile interface unit using the global positioning satellite system;
means in said CPU for correlating said exact current geographic position with said geographic coordinates of a respective hole of said selected golf course record and with a respective digital map representation of said selected golf course record;
a display adapted to digitally display said respective digital map representation of said respective golf course and said exact current geographic position of said mobile interface unit relative thereto;
a plurality of RFID transmitters, each RFID transmitter including a unique identifier;
means for coupling said plurality of transmitters to respective golf clubs of said plurality of golf clubs;
a RFID reader positioned on said mobile interface unit in communication with said CPU, said reader having circuitry for electronically recognizing a respective identifier of a selected RFID transmitter when said selected RFID transmitter is positioned in a predetermined proximity to said RFID reader;
means in said RFID reader for correlating said recognized respective identifier with a corresponding golf club to which said selected RFID transmitter is coupled, said correlating means including means for generating correlation data; and
means in said CPU for updating corresponding data fields of a respective player record with said correlation data when said RFID reader recognizes said respective identifier of said selected RFID transmitter.

2. The golf game management system as in claim 1, wherein said data fields of said at least one golf course record include information associated with each hole of a corresponding golf course indicative of a distance from a respective tee to a respective green thereof and including global geographic coordinates corresponding to each hole;
said system further comprising means in said CPU for correlating said current geographic position with said respective digital map representation for calculating a distance between said current geographic position and said respective green.

3. The golf game management system as in claim 1 further comprising means for updating said data fields of a respective player record, said updating means including:
means at said mobile interface unit for gathering new data from a player associated with said respective player record;
means for directing said new data to said remote computer server, said remote computer server adapted to replace previous player data in said respective player record with said new data.

4. The golf game management system as in claim 1 wherein said data fields of each player record are correlated to a golf course selected from said course database and include previous club selections for each hole associated with said selected golf course, distances a golf ball was hit for each hole associated with said selected golf course, and average scoring for each hole associated with said selected golf course.

5. The golf game management system as in claim 1 further comprising a transmitter electrically connected to said CPU adapted to selectably generate and transmit a signal to a golf ball, said golf ball comprising:
a shock absorbent housing defining an interior chamber;
a micro-battery positioned in said chamber;
a sound generator positioned in said chamber and electrically connected to said micro-battery; and
a miniature receiver positioned in said chamber and electrically connected to said micro-battery and adapted to receive said signal, said receiver permitting current from said micro-battery to energize said sound generator upon receiving said signal.

6. The golf game management system as in claim 1 wherein said means for receiving a user-selected golf course record and said means for receiving a user-selected player record is a receiver.

7. The golf game management system as in claim 3 wherein said means for directing said new data to said remote computer server is a transmitter electrically connected to said CPU.

8. The golf game management system as in claim 1 further comprising:
means for coupling at least one of said plurality of RFID transmitters to at least one golf ball; and
means in said RFID reader for correlating said recognized respective identifier with a corresponding golf ball to which said selected RFID transmitter is coupled, said correlating means including means for generating correlation data.

9. The golf game management system as in claim 1 further comprising:
means in said CPU for displaying on said display a trajectory path of a user golf shot according to a previous current geographic position of said mobile interface unit and a present current geographic position of said mobile interface unit; and
means in said CPU for displaying a predetermined trajectory path of a hypothetical golf shot from said previous current geographic position of said mobile interface unit for comparison of said hypothetical golf shot with said user golf shot.

10. The golf game management system as in claim 1 further comprising:
at least one sensor mounted to said plurality of golf clubs for collecting data associated with the mechanics of a golf swing and impact of a selected golf club with a golf ball;
a transmitter electrically connected to said at least one sensor for transmitting data collected by said at least one sensor to said CPU; and
means in said CPU for calculating an impact force upon said golf ball utilizing said transmitted data and predetermined masses of said golf ball and said selected golf club.

11. The golf game management system as in claim 10 wherein said at least one sensor is one of an accelerometer, angular rate sensor, strain gauge, and pressure transducer.

12. The golf game management system as in claim 1 wherein said mobile interface unit includes a plurality of environmental sensors in communication with said CPU such that weather condition data may be recorded in a respective player record relative to a particular golf hole.

13. The golf game management system as in claim 12 wherein said environmental sensors include precipitation, wind, and temperature sensors.

14. The golf game management system as in claim 1 further comprising:
a camera electrically connected to said CPU for selectably recording a video clip of game play; and
means in said CPU for directing said recorded video clip to said remote computer, said remote computer adapted to store said recorded video clip in a respective player record.

15. A golf game management system for acquiring golf course, player, and golf ball location information upon demand by a golfer during game play, said system comprising:
a mobile interface unit having a central processing system (“CPU”);
means connected to said CPU for receiving a user-selected golf course record from a remote computer server having a course database, said course database having at least one golf course record containing a plurality of data fields;
wherein said plurality of data fields of said at least one golf course record includes a digital map representation of a corresponding golf course and geographic coordinates of the boundaries of each hole of said corresponding golf course;
means connected to said CPU for receiving a user-selected player record from said remote computer, said remote computer including a player database having a plurality of player records with each player record having a plurality of data fields indicative of individual player information;
a memory connected to said CPU for storing said user-selected golf course record and said user-selected player record;
a GPS receiver for receiving GPS signals and for determining a current geographic position of said mobile interface unit using the global positioning satellite system;
means in said CPU for correlating said current geographic position with said geographic coordinates of a respective hole of said selected golf course record and with a respective digital map representation of said selected golf course record; and
a display adapted to digitally display said respective digital map representation of said respective golf course and said current geographic position of said mobile interface unit relative thereto.

16. A golf game management system for use by a golfer playing a round of golf with a plurality of golf clubs, said golf game management system for acquiring golf course, player, and golf ball location information upon demand by a golfer during game play, said system comprising:
a mobile interface unit having a central processing system (“CPU”);
means connected to said CPU for receiving a user-selected golf course record from a remote computer server having a course database, said course database having at least one golf course record containing a plurality of data fields;
wherein said plurality of data fields of said at least one golf course record includes a digital map representation of a corresponding golf course and geographic coordinates of the boundaries of each hole of said corresponding golf course;
means connected to said CPU for receiving a user-selected player record from said remote computer, said remote computer including a player database having a plurality of player records with each player record having a plurality of data fields indicative of individual player information;
a memory connected to said CPU for storing said user-selected golf course record and said user-selected player record;
a GPS receiver for receiving GPS signals and for determining an exact current geographic position of said mobile interface unit using the global positioning satellite system;
means in said CPU for correlating said exact current geographic position with said geographic coordinates of a respective hole of said selected golf course record and with a respective digital map representation of said selected golf course record;
a display adapted to digitally display said respective digital map representation of said respective golf course and said exact current geographic position of said mobile interface unit relative thereto;
a plurality of RFID transmitters, each RFID transmitter including a unique identifier;
means for coupling said plurality of transmitters to respective golf clubs of said plurality of golf clubs;
a RFID reader positioned on said mobile interface unit in communication with said CPU, said reader having circuitry for electronically recognizing a respective identifier of a selected RFID transmitter when said selected RFID transmitter is positioned in a predetermined proximity to said RFID reader;
means in said RFID reader for correlating said recognized respective identifier with a corresponding golf club to which said selected RFID transmitter is coupled, said correlating means including means for generating correlation data;
means in said CPU for updating corresponding data fields of a respective player record with said correlation data when said RFID reader recognizes said respective identifier of said selected RFID transmitter;
means in said CPU for displaying on said display a trajectory path of a user golf shot according to a previous current geographic position of said mobile interface unit and a present current geographic position of said mobile interface unit; and
means in said CPU for displaying a predetermined trajectory path of a hypothetical golf shot from said previous current geographic position of said mobile interface unit for comparison of said hypothetical golf shot with said user golf shot.

17. The golf game management system as in claim 16 further comprising:
at least one sensor mounted to said plurality of golf clubs for collecting data associated with the mechanics of a golf swing and impact of a selected golf club with a golf ball;
a transmitter electrically connected to said at least one sensor for transmitting data collected by said at least one sensor to said CPU; and
means in said CPU for calculating an impact force upon said golf ball utilizing said transmitted data and predetermined masses of said golf ball and said selected golf club.

18. The golf game management system as in claim 16 wherein said mobile interface unit includes a plurality of environmental sensors in communication with said CPU such that weather condition data may be recorded in a respective player record relative to a particular golf hole.

19. The golf game management system as in claim 18 wherein said environmental sensors include precipitation, wind, and temperature sensors.

20. The golf game management system as in claim 16 further comprising:
a camera electrically connected to said CPU for selectably recording a video clip of game play; and
means in said CPU for directing said recorded video clip to said remote computer, said remote computer adapted to store said recorded video clip in a respective player record.
